(19) United States
(12) Patent Application Publication
(10) Pub. No.: US 2005/0283984 A1
(43) Pub. Date: Dec. 29, 2005

(54) Shoe assembly for power tool power tool incorporating such assembly

(76) Inventor: Neil Walmsley, Ferryhill (GB)

Correspondence Address: Michael P. Leary;Group Patent Counsel, Black & Decker Corporation, 701 E. Joppa Rd, Mail Stop TW199, Towson, MD, 21286, US

(21) Appl. No.: 10/952,257

(22) Filed: Sep. 28, 2004

(30) Foreign Application Priority Data
Jun. 29, 2004 (GB) GB 0414465.5

(51) Int. Cl. F16D 51/00; B27B 3/12

(52) U.S. Cl. 30/394

(57) ABSTRACT

A shoe assembly for a power tool comprises a shoe portion including a cast and a sole plate adapted to engage a workpiece. The cast has a raised portion having a series of recesses on an interior surface thereof. The shoe assembly also includes a mounting portion for mounting the shoe portion to the housing of the tool. The mounting portion includes a resiliently displaceable ball bearing in a housing mounted to a clamp plate for engaging the recess on the raised portion of the cast in order to selectively releasably hold the shoe portion in one of a plurality of predetermined orientations relative to the mounting portion.

### FIELD OF THE INVENTION

The present invention relates to a shoe assembly for a power tool and relates particularly, but not exclusively, to a shoe assembly for a jigsaw. The invention also relates to power tools incorporating such assemblies.

### BACKGROUND OF THE INVENTION

Jigsaws are power tools housing a motor for reciprocatingly driving a blade. The housing generally rests on a shoe assembly for supporting the saw on a workpiece, and the blade projects through the shoe in order to cut the workpiece. Jigsaws can also be equipped to perform bevel cutting, in which the blade is tilted about the longitudinal axis of the shoe in order to produce angular cuts in the workpiece.

Bevel cutting jigsaws are known which have preset angular inclinations, and mechanisms for locking the blade at an angle to the workpiece. U.S. Pat. No. 6,357,124 describes a clamping mechanism for a bevel-cutting jigsaw in which deflectable ball bearings are held on the underside of a housing of the jigsaw in order to resiliently engage indentations formed on the upper surface of a shoe of the jigsaw. There are several indentations formed at predetermined angles, so that as the housing is pivoted about the shoe, the ball bearings move resiliently in and out of the indentations. A locking mechanism is also provided to clamp the housing and shoe at a selected angle relative to each other.

This prior art bevel-cutting jigsaw suffers from the drawback that the ball bearings push the shoe away from the housing, making the pivoting movement of the shoe jerky and awkward.

### BRIEF SUMMARY OF THE INVENTION

Preferred embodiments of the present invention seek to overcome the above disadvantage of the prior art.

According to an aspect of the present invention, there is provided a shoe assembly for a power tool having a housing, at least one working member for engaging a workpiece, and a motor for causing movement of the or each said working member relative to the housing, the shoe assembly comprising:—
a shoe portion adapted to engage a workpiece and having at least one recess provided on a surface thereof facing away from the housing of the tool in use; and
a mounting portion for mounting the shoe portion to the housing of the tool, the mounting portion having at least one resiliently displaceable projection adapted to engage at least one said recess to selectively releasably hold the shoe portion in one of a plurality of predetermined orientations relative to the mounting portion.

By providing a shoe portion with at least one recess provided on a surface facing away from the housing of the tool in use, engaging at least one resiliently displaceable projection, this provides the advantage of making the pivoting movement of the shoe smoother, and less awkward for the user, than in prior art devices. In a preferred embodiment, at least one said resiliently displaceable projection comprises a respective spring-loaded ball bearing. This provides the advantage that the ball bearing slides easily in and out of engagement with the respective recesses as pressure is applied to the shoe.

In a preferred embodiment, at least one said spring-loaded ball bearing, at least one said clamp plate having a respective arcuate upper surface adapted to slidably engage the shoe portion such that at least one corresponding said ball bearing can selectively resiliently engage each of a plurality of said recesses of the shoe portion in response to a user pivoting said housing relative to said shoe member. This provides the advantage of increasing the strength of the link between the shoe and the housing.

The assembly may further comprise first locking means adapted to lock said shoe portion in a predetermined orientation relative to the mounting portion. This provides the advantage of preventing unwanted pivoting of the shoe, and increasing the safety of the assembly. In a preferred embodiment, said first locking means comprises at least one first bolt adapted to lock at least one said clamp plate to the shoe portion. In a preferred embodiment, rotation of at least one said first bolt in a first sense causes at least one corresponding said clamp plate to disengage from the surface of said shoe potion, and rotation in the opposite sense causes at least one corresponding said clamp plate to engage the surface of said shoe portion in order to lock the clamp plate to the shoe portion.

The first locking means may further comprise at least one nut rotatably mounted to said housing and adapted to receive at least one said first bolt. In a preferred embodiment, at least one said nut comprises a respective lever for rotation of said nut relative to said housing. This provides the advantage of providing easy rotation of the nut for the user.

In a preferred embodiment the assembly further comprises second locking means adapted to prevent rotation of at least one said first bolt relative to a said clamp plate engaged by said bolt. This provides the advantage of locking the nut lever in place, such that the user accidentally moving the lever cannot loosen the shoe assembly. Said second locking means may comprise at least one second bolt and at least one washer, at least one said second bolt received in at least one said clamp plate such that in a first position, at least one said washer abuts a said first bolt and prevents rotation of said first bolt, and such that in a second position rotation of the first bolt is permitted.

According to another aspect of the present invention, there is provided a reciprocating tool having a body, a rotary output shaft, a reciprocating member for causing a working member to execute reciprocating motion in response to rotation of said rotary output shaft, and a shoe assembly as defined above.

In a preferred embodiment, the tool further comprises dust extraction means adapted to remove dust produced by the action of said working member on a workpiece. This provides the advantage removing dust from the vicinity of the tool and the user. Said dust extraction means may comprise a tube projecting from said shoe portion adapted to be connected to a source of suction.

In a preferred embodiment, said reciprocating tool is a jigsaw.

### BRIEF DESCRIPTION OF THE DRAWINGS

A preferred embodiment of the present invention will now be described, by way of example only and not in any limitative sense, with reference to the accompanying drawings, in which:—

FIG. 1 is a side view of a jigsaw embodying the present invention;

FIG. 2 is an exploded perspective view from the front and one side of a shoe assembly of the jigsaw of FIG. 1;

FIG. 3 is an exploded side perspective view of the shoe assembly of FIG. 2;

FIG. 4 is a cross sectional view from the side of part of the jigsaw of FIG. 1;

FIG. 5 is a cross sectional view of the ball bearing and ball bearing housing of the show assembly of FIG. 2;

FIG. 6 is a perspective view from below of the shoe cast of the assembly of FIG. 2; and

FIG. 7 is a perspective view from below of the shoe cast of FIG. 6 incorporating a guard rail.

### DETAILED DESCRIPTION OF THE INVENTION

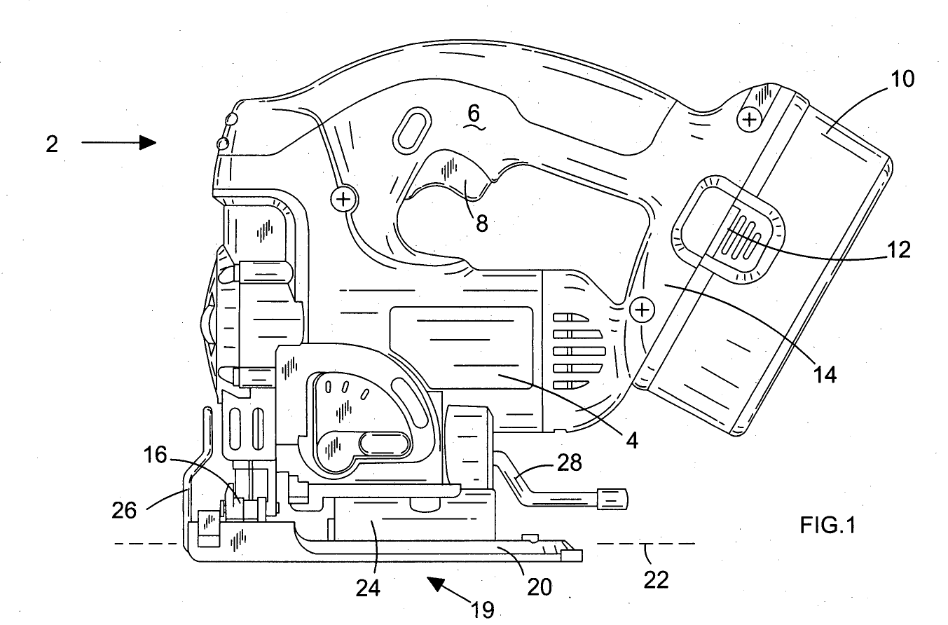

Referring to FIG. 1, a jigsaw 2 comprises a housing 4 formed from moulded plastics material in two clamshell halves (not shown) as will be familiar to persons skilled in the art. A handle 6 is integrally formed with the housing 4 to allow a user to grip the jigsaw 2 and depress switch 8 to activate a motor (not shown) of the jigsaw 2. A removable and rechargeable battery pack 10 is shown mounted to the housing 4. The battery pack 10 is removed from the housing 4 by depressing resilient clips 12, and the action of pushing the battery pack 10 back into rear portion 14 of the housing 4 displaces resilient clips 12 such that the battery pack 10 locks in place on the rear of housing 4.

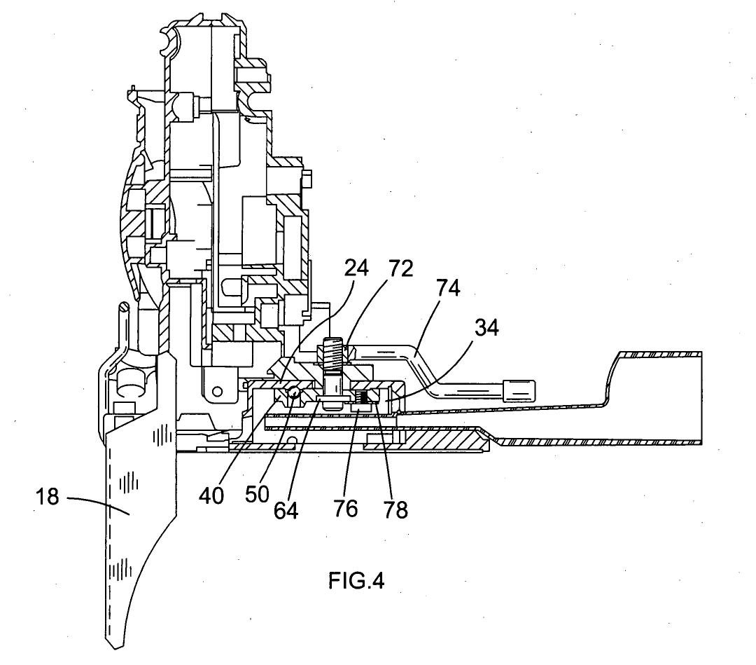

A blade clamp 16 releasably holds a jigsaw blade (not shown), and executes reciprocating vertical movement when the jigsaw motor is activated. The blades may be of the standard type, or of the flush-cut type as shown in FIG. 4 and which extend further forwards than standard blades, for example to enable a cut to be made close to a surface such as a wall.

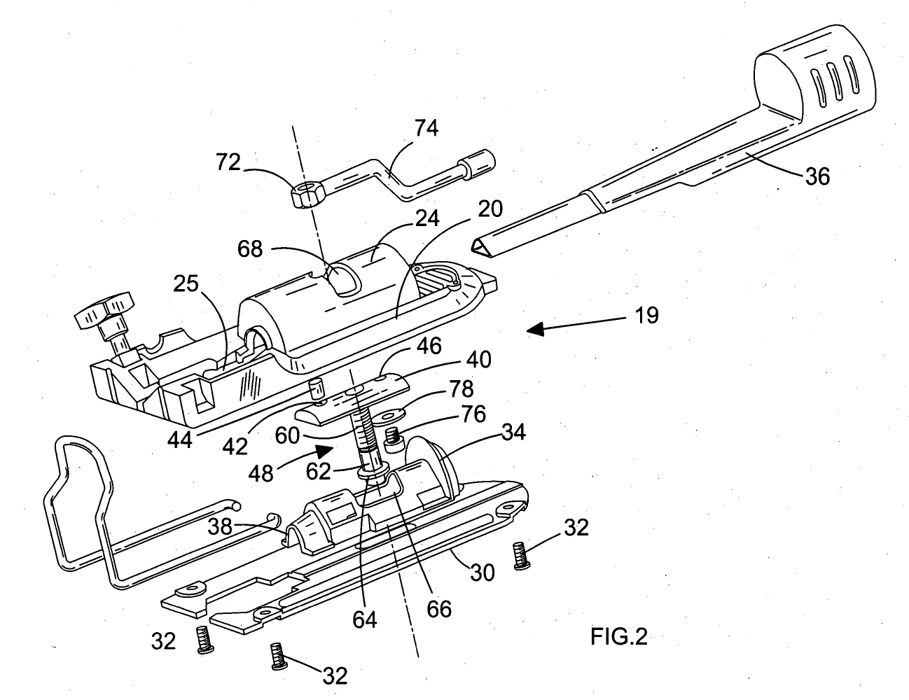

A shoe assembly 19 includes a metal cast 20 pivotable about an axis 22 generally parallel to a cutting plane of the jigsaw 2. A raised portion 24 of cast 20 abuts the underside of the housing 4 such that the housing 4 is supported on the shoe assembly 19. An aperture 25 (FIG. 2) is formed in the cast 20 below blade clamp 16 in order to allow the jigsaw blade to pass through the cast 20. A guard rail 26 is attached to the front end of cast 20. The guard rail prevents objects from coming into contact with the blade (not shown). A lever 28 also projects from the housing 4, the purpose of which will be described in more detail below.

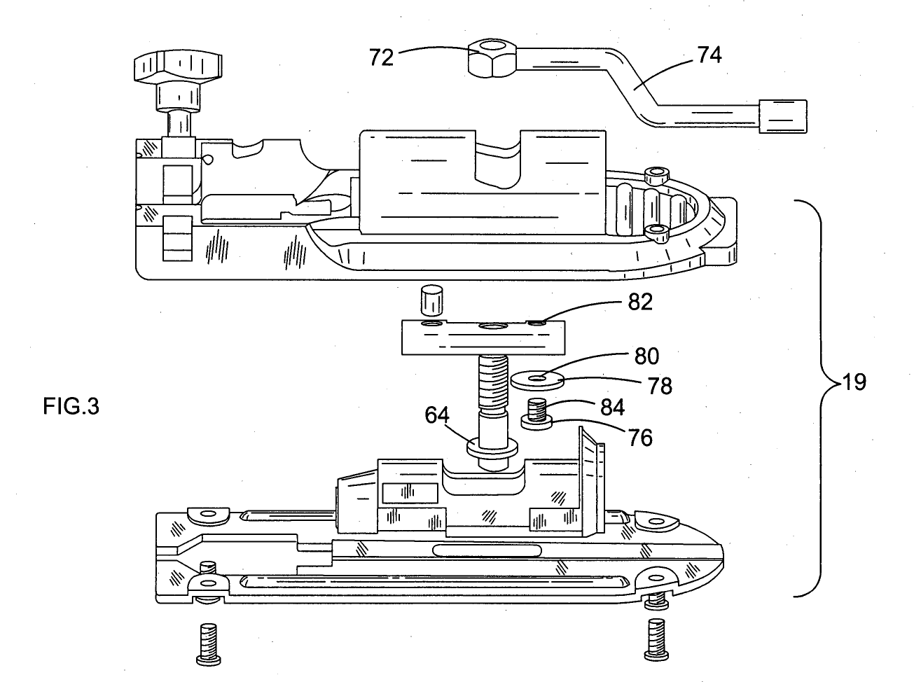

Referring to FIGS. 2 to 4, a sole plate 30 is adapted to be attached to the cast 20 by screws 32. Located between the sole plate 30 and the cast 20 is an adaptor 34 for receiving a suction pipe 36. The suction pipe 36 passes through the rear of raised portion 24, into adaptor 34 and is able to suck dust through the front end of adaptor 38. A clamp plate 40 is also located between sole plate 30 and cast 20, the clamp plate 40 having a first aperture 42 for holding ball bearing housing 44. The clamp plate 40 also has a cylindrical bore 46 to allow bolt 48 to pass through.

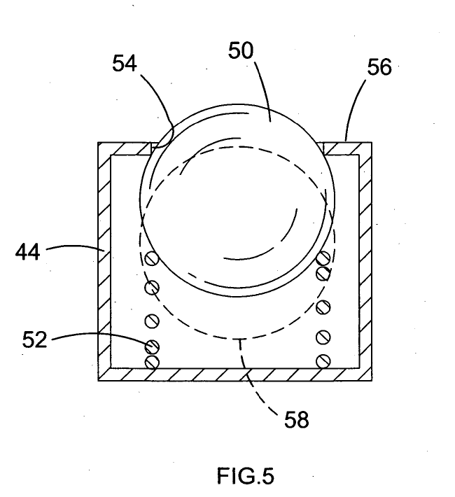

Referring to FIG. 5, a ball bearing 50 is held in ball bearing housing 44, and mounted on top of a coil spring 52. A circular aperture 54 is formed in the upper surface 56 of ball bearing housing 44. The radius of circular aperture 54 is less than that of the radius of the ball bearing 50, so that the ball bearing cannot pass through aperture 54 but can project through the aperture to a limited extent as shown by the solid line in FIG. 5. The ball bearing 50 can also be depressed against coil spring 52 to be positioned shown by broken line 58 such that the ball bearing does not project beyond the upper surface 56 of ball bearing housing 44.

Referring to FIGS. 2 to 4, the ball bearing housing 44 fits inside aperture 42 formed in the top of clamp plate 40. Bolt 48 comprises a threaded portion 60, a smooth portion 62 and a flange section 64. Adaptor 34 has an opening 66 having a width less than the diameter of flange 64, such that flange 64 abuts against the edges of the underside of opening 66. The smooth section 62 of the bolt 48 rests in cylindrical bore 46 of the clamp plate 40 such that the adaptor 34 is supported by the bolt 48 and clamp plate 46 is mounted on top of adaptor 34. The threaded portion 60 of the bolt passes through opening 68 formed in the raised portion 24 of the cast 20.

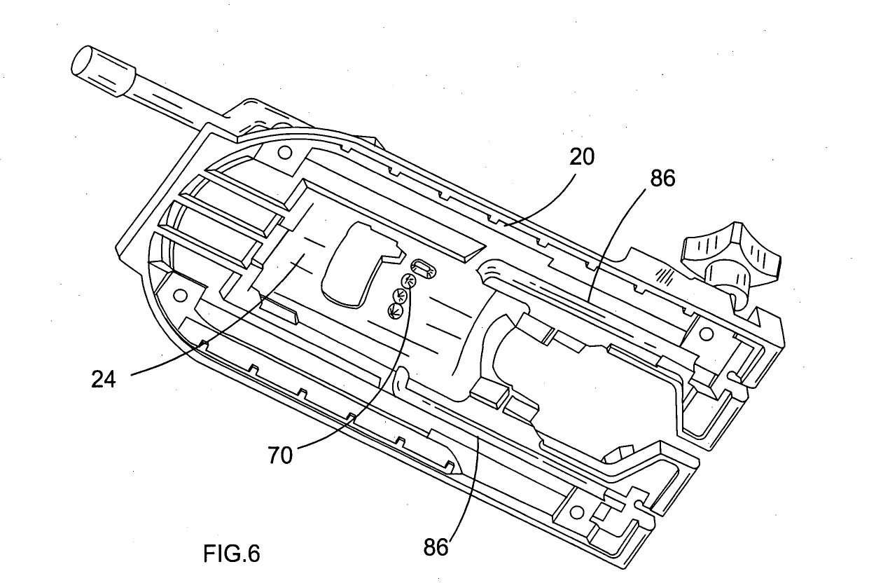

Referring to FIG. 6, a plurality of indentations 70 are formed in the underside of raised portion 24 of the cast 20. The upper surface of clamp plate 40 has an arcuate shape to allow it to slidably engage the underside of raised portion 24, and ball bearing 50 projects from ball bearing housing 44 and clamp plate 40, under the force of compression spring 52, such that the ball bearing 50 is pushed into one of the indentations 70.

The method of pivoting the shoe assembly 19 relative to housing 4 will now be described with reference to FIGS. 2 to 6.

A nut 72 held in housing 4 has an inner screw thread (not shown) adapted to receive screw thread 60 of bolt 48. The nut 72 has a lever 74 extending from it, and rotation of the lever raises or lowers bolt 48 depending on the direction in which lever 74 is turned. Flange section 64 of bolt 48 abuts the underside of the edges of opening 66 of the adaptor 34, and pushes clamp plate 40 into sliding engagement with the underside of raised portion 24 of the cast 20. This causes ball bearing 50 to be held in one of the indentations 70, thus holding the shoe at a predetermined angle relative to the housing 4.

In order to change the angle of the shoe assembly 19 relative to the housing 4, and thus the angle of blade 18 relative to a workpiece, lever 74 is rotated in order to lower the adaptor 34 and clamp plate 40 away from the underside of raised portion 24 of cast 20. This allows compression spring 52 to extend, and ball bearing 50 to project through aperture 54. The cast 20 can then be pivoted relative to the housing 4. It will be understood that as adaptor 34 is connected to housing 4 via bolt 48, the adaptor 34 moves inside of raised portion 24 with the housing 4. During the pivoting motion, the ball bearing 50 rolls in and out of indentations 70 under the influence of coil spring 52 until the user selects the desired angular orientation of the shoe assembly 19. Lever 74 can then be moved in the opposite direction, causing bolt 48 to move upwardly due to the engagement of the screw thread of the nut with the screw thread 60 of the bolt, raising clamp plate 40 into a tight engagement with the underside of raised portion 24, locking the shoe assembly 19 in place.

When the shoe assembly 19 is set at the desired angle, a further locking mechanism comprising a second bolt 76 and a washer 78 is provided to prevent lever 74 being accidentally rotated to loosen the assembly. Second bolt 76 is held in the circular aperture 80 of washer 78. Clamp plate 40 has a second bore 82 having an internal screw thread adapted to engage the threaded portion 84 of second bolt 76. Referring to FIG. 4, the washer 78 abuts the underside of flange 64 of the first bolt 48. When second bolt 84 is screwed tightly into clamp plate 82, the flange 64 of the first bolt is trapped between washer 78 and the underside of clamp plate 40. As a result of this, the first bolt 48 cannot be raised or lowered, therefore holding lever 74 in place and fixing the shoe assembly 19 at a set angle relative to the housing 4.

In order to unlock first bolt 48, the second bolt can be accessed by the user from the underside of the cast 20 and loosened, thus moving washer 78 away from the underside of clamp plate 40 and creating a limited space in which flange 64 can move up and down.

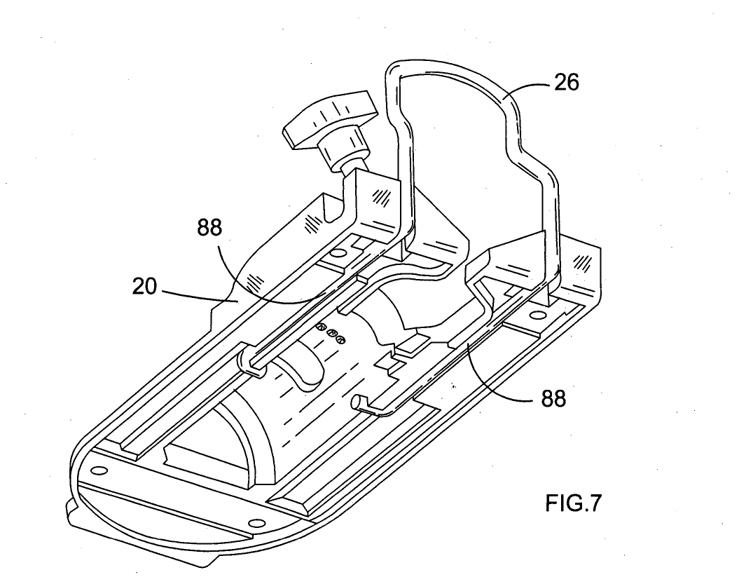

Referring to FIGS. 6 and 7, a groove 86 is formed along each side of the underside of cast 20. A guardrail 26 is formed from a single piece of steel, bent to form two legs 88 such that the legs 88 are received in groove 86. By mounting the guard rail in this way, the legs 88 provide reinforcement to the cast 20.

It will be appreciated by persons skilled in the art that the above embodiment has been described by way of example only and not in any limitative sense, and that various alterations and modifications are possible without departure from the scope of the invention as defined by the appended claims. For example, more than one resiliently biased ball bearing 50 may be provided, and the shoe assembly 19 may be held in the desired orientation relative to housing 4 solely by means of resilient engagement of a ball bearing 50 with an indentation 70, i.e. without the use of the second bolt 76 and washer 78.

1. A shoe assembly for a power tool having a housing, a working member for engaging a workpiece, and a motor for causing movement of the working member relative to the housing, the shoe assembly comprising:—
a shoe portion including a surface facing away from the housing of the tool, the surface defining at least one recess therein; and
a mounting portion for mounting portion having a resiliently displaceable projection adapted to engage the at least one recess to selectively releasably hold the shoe portion in one of a plurality of predetermined orientations relative to the mounting portion.

2. An assembly according to claim 1, wherein the resiliently displaceable projection comprises a spring-loaded ball bearing.

3. An assembly according to claim 2, wherein the mounting portion further comprises a clamp plate for supporting the spring-loaded ball bearing, said clamp plate having an arcuate upper surface adapted to slidably engage the shoe portion such that said ball bearing can selectively resiliently engage the at least one recess of the shoe portion in response to a user pivoting said tool housing relative to said shoe portion.

4. An assembly according to claim 1 and further comprising first locking means adapted to lock said shoe portion relative to the mounting portion.

5. An assembly according to claim 3 and further comprising a first bolt adapted to lock the clamp plate to the shoe portion.

6. An assembly according to claim 5, wherein rotation of the first bolt in a first direction loosens the clamp plate from the surface of the shoe potion, and rotation of the first bolt in a second direction causes tightens the clamp plate against the surface of the shoe portion in order to lock the clamp plate to the shoe portion.

7. An assembly according to claim 5 and further comprising a nut rotatably mounted in the tool housing and operatively engaged with the first bolt.

8. An assembly according to claim 7, wherein the nut includes a lever for rotation of the nut relative to the housing.

9. An assembly according to claim 5 and further comprising second locking means adapted to prevent rotation of the first bolt relative to the clamp plate.

10. An assembly according to claim 9, wherein said second locking means includes a second bolt and a washer, the second bolt engaging the clamp plate and the washer such that when the second bolt is in a first position, the washer abuts the first bolt and prevents rotation of said first bolt, and such that when the second bolt is in a second position rotation of the first bolt is permitted.

11. A reciprocating tool comprising
a body;
a reciprocating member for causing a working member to execute reciprocating; and
a shoe assembly comprising:
a shoe portion including a surface facing away from the body of the tool, the surface defining at least one recess therein; and
a mounting portion, the mounting portion having a resiliently displaceable projection adapted to engage the at least one recess to selectively releasably hold the shoe portion in one of a plurality of predetermined orientations relative to the mounting portion.

12. A tool according to claim 11, further comprising dust extraction means adapted to remove dust produced by the action of said working member on a workpiece.

13. A tool according to claim 12, wherein said dust extraction means comprises a tube projecting from said shoe portion and adapted to be connected to a source of suction.

15. A tool according to claim 2, wherein the tool is a jigsaw.

16. A jigsaw comprising:
a saw housing;
a saw shoe pivotably connected to the saw housing, the saw shoe having a first surface opposite the saw housing and defining a plurality of recesses, the recesses located at positions corresponding to predetermined pivot angles between the saw housing and the saw shoe;
a clamp plate engageable with the first surface of the saw shoe;
a clamping mechanism operatively connected with the saw housing and the clamp plate for one of selectively tightening and loosening the clamp plate against the first surface of the saw shoe; and
a resilient detent for selectably engaging one of the plurality of recesses in the interior surface of the saw shoe.

17. A jigsaw according to claim 16, wherein the resilient detent comprises a ball bearing and a spring, the spring urging the ball bearing toward the first surface of the saw shoe.

18. The jigsaw according to claim 17, wherein the resilient detent further comprises a housing, and the spring and ball bearing are located in the housing, and the housing is located in the clamp plate.

19. The jigsaw of claim 16, wherein the clamping mechanism includes a bolt and a nut, the bolt operatively connected with the saw housing and extending through a first opening in the saw shoe and a second opening in the clamp plate, the nut threadably engaged with the bolt, and one of the bolt and nut selectably rotatable in order to clamp together the saw shoe, clamp plate, and saw housing

20. A method of setting the bevel cutting angle of a jig saw comprising a saw body, a saw shoe, a clamping assembly, and a resilient detent selectable to one of a plurality of bevel cutting angles, the method of setting the bevel cutting angle including the steps of:
loosening the clamping assembly;
moving the saw body relative to the saw shoe until the resilient detent engages at the desired bevel cutting angle; and
tightening the clamping assembly.
